(19) United States
(12) Patent Application Publication
(10) Pub. No.: US 2013/0097704 A1
(43) Pub. Date: Apr. 18, 2013

(54) Handling Noise in Training Data for Malware Detection

(71) Applicant: Bitdefender IPR Management Ltd., Nicosia (CY)

(72) Inventors: Dragos GAVRILUT, Iasi (RO); Marius BARAT, Iasi (RO); Liviu V. CIORTUZ, Iasi (RO)

(73) Assignee: BITDEFENDER IPR MANAGEMENT LTD., Nicosia (CY)

(21) Appl. No.: 13/651,409

(22) Filed: Oct. 13, 2012

Related U.S. Application Data
(60) Provisional application No. 61/546,712, filed on Oct. 13, 2011.

(51) Int. Cl. G06F 21/00

(52) U.S. Cl. 726/23

(57) ABSTRACT

Described systems and methods allow the reduction of noise found in a corpus used for training automatic classifiers for anti-malware applications. Some embodiments target pairs of records, which have opposing labels, e.g. one record labeled as clean/benign, while the other labeled as malware. When two such records are found to be similar, they are identified as noise and are either discarded from the corpus, or relabeled. Two records may be deemed similar when, in a simple case, they share a majority of features, or, in a more sophisticated case, they are sufficiently close in a feature space according to some distance measure.

### BACKGROUND

The invention relates to systems and methods for computer malware detection, and in particular, to systems and methods of training automated classifiers to distinguish malware from legitimate software.

Malicious software, also known as malware, affects a great number of computer systems worldwide. In its many forms such as computer viruses, worms, rootkits, and spyware, malware presents a serious risk to millions of computer users, making them vulnerable to loss of data and sensitive information, identity theft, and loss of productivity, among others.

A great variety of automated anti-malware systems and methods have been described. They typically comprise content-based methods and behavior-based methods. Behavior-based methods conventionally rely on following the actions of a target object (such as a computer process), and identifying malware-indicative actions, such as an attempt by the target object to modify a protected area of memory. In content-based malware detection, such as signature match, a set of features extracted from a target object is compared to a set of features extracted from a reference collection of objects including confirmed malware and/or legitimate objects. Such a reference collection of objects is commonly known as a corpus, and is used for training automated malware filters, for instance neural networks, to discriminate between malware and legitimate software according to said features.

In conventional classifier training, training corpuses are typically assembled under human supervision. Due to the proliferation of computer malware, corpuses may reach considerable size, comprising millions of malware and/or clean records, and may need frequent updating to include newly discovered malware. Human supervision on such a scale may be unpractical. Automatic corpus gathering typically relies on automated classification methods, which may accidentally mislabel a legitimate object as malware, or malware as legitimate. Such mislabeled records are commonly known as training noise, and may affect the performance of an automated classifier trained on the respective noisy corpus.

There is considerable interest in developing systems and methods of automated construction of noise-free corpuses for training classifiers for anti-malware applications.

### SUMMARY

According to one aspect, a computer system comprises at least one processor configured to form a set of noise detectors, each noise detector of the set of noise detectors configured to de-noise a corpus of records, and wherein the corpus is pre-classified into a subset of clean records and a subset of malware records prior to de-noising. De-noising the corpus comprises: selecting a first record and a second record from the corpus, the first record being labeled as clean and the second record being labeled as malware; in response to selecting the first and second records, determining whether the first and second records are similar according to a set of features; and in response, when the first and second records are similar, determine that the first and second records are noise.

According to another aspect, a method comprises employing at least one processor of a computer system to select a first record and a second record from a corpus, wherein the corpus is pre-classified into a subset of clean records and a subset of malware records prior to selecting the first and second records, and wherein the first record is labeled as clean and the second record is labeled as malware. The method further comprises, in response to selecting the first and second records, employing the at least one processor to determine whether the first and second records are similar according to a set of features, and in response, when the first and second records are similar, employing the at least one processor to determine that the first and second records are noise.

According to another aspect, a computer readable medium stores a set of instructions, which, when executed by a computer system, cause the computer system to form a record aggregator and a noise detector connected to the record aggregator. The record aggregator is configured to assign records of a corpus to a plurality of clusters, wherein each record of the corpus is pre-labeled as either clean or malware prior to assigning records to the plurality of clusters, and wherein all members of a cluster of the plurality of clusters share a selected set of record features. The record aggregator is further configured, in response to assigning the records to the plurality of clusters, to send a target cluster of the plurality of clusters to the noise detector for de-noising. The noise detector is configured, in response to receiving the target cluster, to select a first record and a second record from the target cluster, the first record being labeled as clean and the second record being labeled as malware; in response to selecting the first and second records, to determine whether the first and second records are similar according to a set of features; and in response, when the first and second records are similar, to determine that the first and second records are noise.

### BRIEF DESCRIPTION OF THE DRAWINGS

The foregoing aspects and advantages of the present invention will become better understood upon reading the following detailed description and upon reference to the drawings where:

FIG. 1 shows an exemplary anti-malware system according to some embodiments of the present invention.

FIG. 2 shows an exemplary hardware configuration of a de-noising engine computer system according to some embodiments of the present invention.

FIG. 3 illustrates exemplary components executing on the de-noising engine, according to some embodiments of the present invention.

FIG. 4 illustrates the operation of an exemplary feature extractor and an exemplary feature vector associated to a corpus record, according to some embodiments of the present invention.

FIG. 5 shows a plurality of feature vectors grouped into clusters, represented in a multidimensional feature space according to some embodiments of the present invention.

FIG. 6 illustrates an exemplary feature tree, wherein each branch comprises a cluster of feature vectors, according to some embodiments of the present invention.

FIG. 7 shows a functional diagram of an exemplary noise detector, forming a part of the de-noising engine of FIG. 3, according to some embodiments of the present invention.

FIG. 8 shows an exemplary sequence of steps performed by the de-noising engine according to some embodiments of the present invention.

FIG. 9 shows an exemplary sequence of steps performed by an embodiment of noise detector employing a similarity measure to detect noise, according to some embodiments of the present invention.

FIG. 10 illustrates a cluster of feature vectors, and a target pair of feature vectors identified as noise according to some embodiments of the present invention.

FIG. 11 shows an exemplary sequence of steps executed by an embodiment of noise detector employing a hyperplane to separate malware from legitimate (clean) feature vectors, according to some embodiments of the present invention.

FIG. 12 illustrates a cluster of feature vectors, a hyperplane separating malware from legitimate (clean) feature vectors, and a target feature vector identified as noise according to some embodiments of the present invention.

### DETAILED DESCRIPTION OF PREFERRED EMBODIMENTS

In the following description, it is understood that all recited connections between structures can be direct operative connections or indirect operative connections through intermediary structures. A set of elements includes one or more elements. Any recitation of an element is understood to refer to at least one element. A plurality of elements includes at least two elements. Unless otherwise required, any described method steps need not be necessarily performed in a particular illustrated order. A first element (e.g. data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. Unless otherwise specified, noise denotes a selected member of a corpus of data objects, wherein each member of the corpus is labeled as either malware or legitimate (clean), and wherein the selected member is incorrectly labeled, for instance a selected clean member mislabeled as malware, or a selected malware member mislabeled as clean. Computer readable media encompass non-transitory media such as magnetic, optic, and semiconductor storage media (e.g. hard drives, optical disks, flash memory, DRAM), as well as communications links such as conductive cables and fiber optic links. According to some embodiments, the present invention provides, inter alia, computer systems comprising hardware (e.g. one or more processors) programmed to perform the methods described herein, as well as computer-readable media encoding instructions to perform the methods described herein.

The following description illustrates embodiments of the invention by way of example and not necessarily by way of limitation.

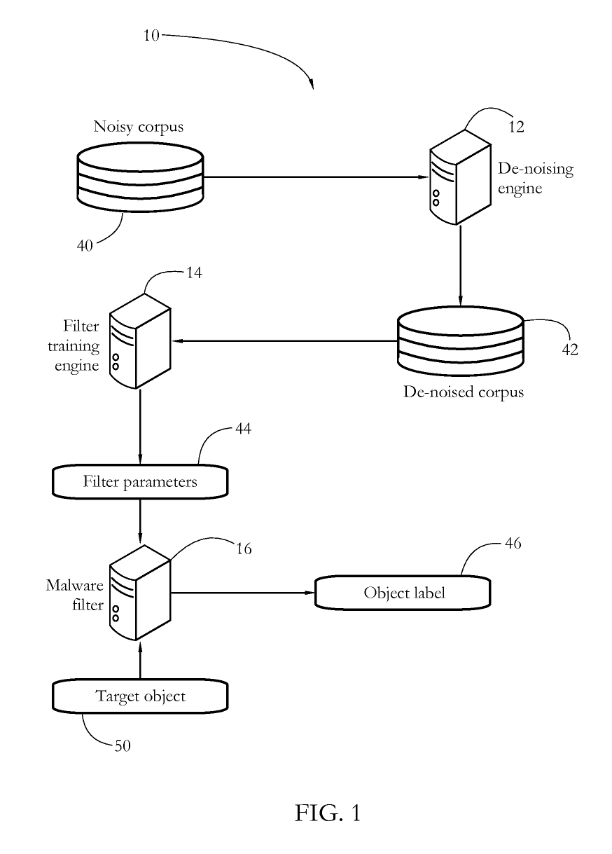

FIG. 1 shows an exemplary anti-malware system 10 according to some embodiments of the present invention. System 10 comprises a de-noising engine 12 connected to a noisy corpus 40 and to a de-noised corpus 42, and further comprises a filter training engine 14 connected to de-noised corpus 42 and to a malware filter 16. In some embodiments, de-noising engine 12 comprises a computer system configured to analyze noisy corpus 40 to produce de-noised corpus 42 as described in detail below.

Noisy corpus 40 comprises a collection of records, each record comprising a data object and a label. In some embodiments, the data object of a corpus record comprises a computer file or a contents of a section of memory belonging to a software object such as a computer process or a driver, among others. Noisy corpus 40 may include records of malware-infected objects, as well as records of legitimate (non-infected) objects. Each record of noisy corpus 40 is labeled with an indicator of its malware status. Exemplary labels include malware and clean, among others. A malware label indicates that the respective record comprises malware, whereas a clean label indicates that the respective record comprises a section of a legitimate computer file and/or process. Such labels may be determined by a human operator upon analyzing the respective record. In some embodiments, labels are produced automatically by a classifier trained to discriminate between malware and clean objects. Noisy corpus 40 may comprise a set of mislabeled records, i.e., malware records wrongly labeled as clean and/or clean records wrongly labeled as malware. Such mislabeled corpus records will be referred to as noise.

For clarity, the description below will only address anti-malware applications, but some embodiments of the present invention may be applied to the field of anti-spam, such as discriminating between legitimate and unsolicited electronic communication. In an exemplary anti-spam embodiment, each record of corpus 40 may comprise an electronic message, labeled either as legitimate or as spam, wherein noise represents mislabeled records.

In some embodiments, noisy corpus 40 is assembled automatically from a variety of sources, such as malware databases maintained by computer security companies or academic institutions, and malware-infected data objects gathered from individual computer systems on a network such as the Internet. In an exemplary embodiment, a computer security provider may set up a centralized anti-malware service to execute on a corporate server. Client computer systems distributed on the network may send data to the centralized server for malware scanning. The centralized service may thus gather malware data in real time, from multiple distributed users, and may store the malware data in the form of corpus records to be used for training malware detector engines. In another embodiment, the computer security provider may set up a decoy computer system on a network, commonly known as a honeypot, and allow the decoy to become infected by malware circulating on the network. The set of malware data is then harvested and stored as corpus records.

In some embodiments, de-noised corpus 42 comprises a subset of records of noisy corpus 40, processed by de-noising engine 12 to remove mislabeled records. Mislabeled records may be removed by discarding the respective records, or by re-labeling them, among others. Exemplary methods for de-noising corpus 40 to produce de-noised corpus 42 are described below.

In some embodiments, filter training engine 14 includes a computer system configured to train an automated filter, for instance a neural network or another form of classifier, to discriminate between malware and legitimate (clean) software objects. In an anti-spam embodiment, filter training engine 14 may be configured to train the automated filter to discriminate between legitimate and spam messages, and/or between various classes of spam. In some embodiments, training comprises having the filter perform a classification of a subset of records from de-noised corpus 42, and adjusting a set of parameter values of the respective filter, often in an iterative fashion, until the filter attains a desired classification performance. Several such filter training methods are known in the art.

As a result of training, filter engine 14 produces a set of filter parameters 44, which represent optimal values of functional parameters for the filter trained by engine 14. In an embodiment comprising a neural network filter, parameters 44 may comprise parameters of a neural network, such as a number of neurons, a number of neuron layers, and a set of neuronal weights, among others. Filter parameters 44 may also comprise a set of malware-identifying signatures and a set of malware-indicative behavior patterns, among others.

In some embodiments, malware filter 16 comprises a computer system, configured to receive a target object 50 and filter parameters 44, and to produce an object label 46 indicating whether target object 50, e.g., a computer file or process, comprises malware. An exemplary embodiment of malware filter 16 is an end-user device such as a personal computer or telecom device, executing a computer security application such as an antivirus program. To determine label 46, malware filter 16 may employ any malware-identifying method known in the art, or a combination of methods. Malware filter 16 comprises an implementation of the filter trained by engine 14, and may be configured to receive filter parameters 44 over a network such as the Internet, e.g., as a software update. Target object 50 may reside on system 16, e.g. a computer file stored on computer-readable media used by malware filter 16, or a contents of a memory used by malware filter 16. In some embodiments, malware system 16 may be configured to receive target object 50 from a remote client system, and to communicate object label 46 to the respective client system over a network such as the Internet.

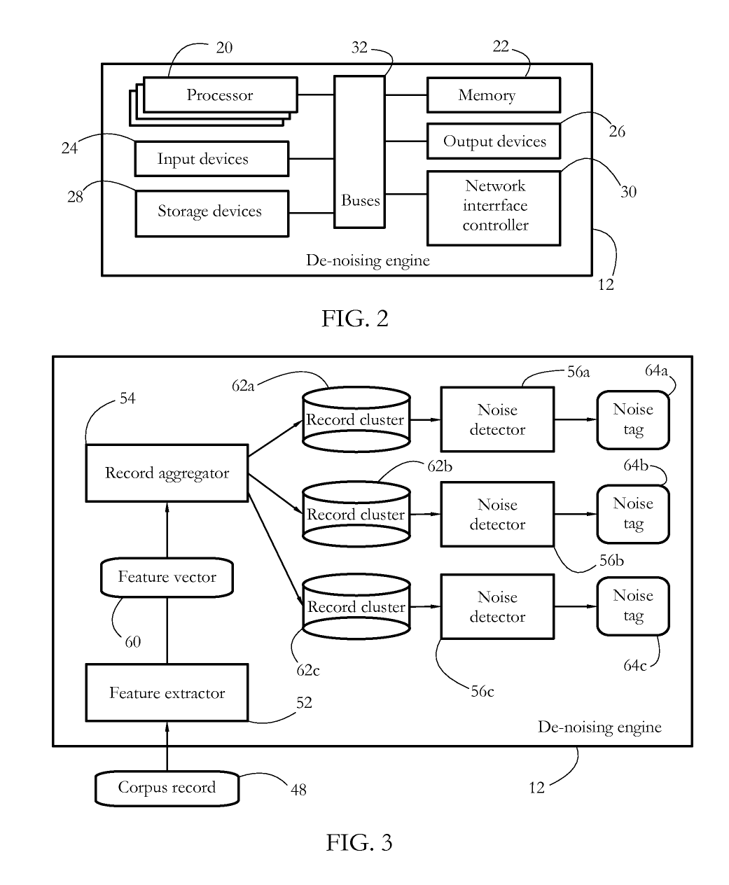

FIG. 2 shows an exemplary hardware configuration of de-noising engine 12, according to some embodiments of the present invention. Engine 12 comprises a set of processors 20, a memory unit 22, a set of input devices 24, a set of output devices 26, a set of storage devices 28, and a network interface controller 30, all connected by a set of buses 32.

In some embodiments, each processor 20 comprises a physical device (e.g. multi-core integrated circuit) configured to execute computational and/or logical operations with a set of signals and/or data. In some embodiments, such logical operations are delivered to processor 20 in the form of a sequence of processor instructions (e.g. machine code or other type of software). Memory unit 22 may comprise volatile computer-readable media (e.g. RAM) storing data/signals accessed or generated by processor 20 in the course of carrying out instructions. Input devices 24 may include computer keyboards, mice, and microphones, among others, including the respective hardware interfaces and/or adapters allowing a user to introduce data and/or instructions into engine 12. Output devices 26 may include display devices such as monitors and speakers among others, as well as hardware interfaces/adapters such as graphic cards, allowing engine 12 to communicate data to a human operator. In some embodiments, input devices 24 and output devices 26 may share a common piece of hardware, as in the case of touch-screen devices. Storage devices 28 include computer-readable media enabling the non-volatile storage, reading, and writing of software instructions and/or data. Exemplary storage devices 28 include magnetic and optical disks and flash memory devices, as well as removable media such as CD and/or DVD disks and drives. Network interface controller 30 enables engine 12 to connect to network 16 and/or to other devices/computer systems. Typical controllers 30 include network adapters. Buses 32 collectively represent the plurality of system, peripheral, and chipset buses, and/or all other circuitry enabling the inter-communication of devices 20-30 of engine 12. For example, buses 34 may comprise the northbridge connecting processor 20 to memory 22, and/or the southbridge connecting processor 20 to devices 24-30, among others. In some embodiments, de-noising engine 12 may comprise only a subset of the hardware devices depicted in FIG. 2.

FIG. 3 shows an exemplary set of software components executing on de-noising engine 12 according to some embodiments of the present invention. De-noising engine 12 includes a feature extractor 52, an object aggregator 54 connected to feature extractor 52, and a set of noise detector applications 56a-c connected to object aggregator 54. In some embodiments, engine 12 is configured to input a corpus record 48 retrieved from noisy corpus 40, and to determine a noise tag 64a-c indicating whether corpus record 48 is noise or not.

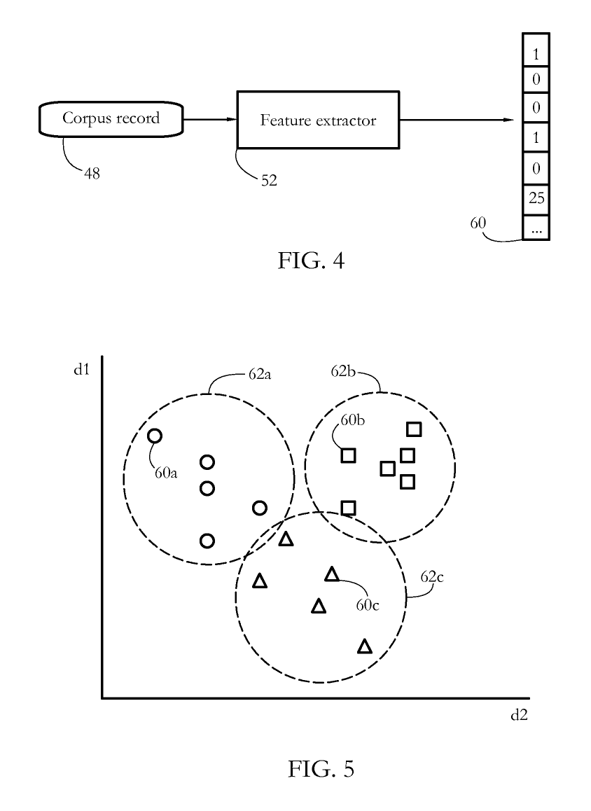

In some embodiments, feature extractor 52 receives corpus record 48 and outputs a feature vector 60 determined for record 48. An exemplary feature vector corresponding to record 48 is illustrated in FIG. 4. Feature vector 60 comprises an ordered list of numerical values, each value corresponding to a measurable feature of the data object (e.g. file or process) forming a part of record 48. Such features may be structural and/or behavioral. Exemplary structural features include a filesize, a number of function calls, and a malware-indicative signature (data pattern), among others. Examples of behavioral features include the respective data object performing certain actions, such as creation or deletion of files, modifications of OS registry entries, and certain network activity indicators, among others. Some elements of feature vector 60 may be binary (1/0, yes/no), e.g. quantifying whether the data object has the respective feature, such as a malware-indicative signature.

In an anti-spam embodiment, feature vector 60 may comprise a set of binary values, each value indicating whether the respective record has a spam-identifying feature, such as certain keywords (e.g., Viagra), or a blacklisted sender, among others. Vector 60 may comprise non-binary feature values, such as a size of a message attachment, or a count of hyperlinks within the respective electronic message, among others.

To produce feature vector 60, feature extractor 52 may employ any method known in the art of malware detection. For example, to determine whether a data object features a malware-indicative signature, feature extractor 52 may execute pattern matching algorithms and/or hashing schemes. To determine a behavior pattern of the data object of record 48, an exemplary extractor 52 may emulate the respective data object in a protected environment known as a sandbox, and/or use an API hooking technique, among others.

In some embodiments, feature vector 60 represents corpus record 48 in a multidimensional feature space, wherein each axis of the space corresponds to a feature of the data object of record 48. FIG. 5 shows a plurality of feature vectors 60a-c represented in an exemplary 2-D feature space having two axes, d1 and d2. In some embodiments, object aggregator 54 is configured to divide a plurality of records 48 from noisy corpus 40 into a plurality of clusters (classes), such as the exemplary clusters 62a-c illustrated in FIG. 5. Each such cluster may be analyzed by noise detectors 56a-c independently of other clusters. Such clustering may facilitate de-noising of noisy corpus 40 by reducing the size of the data set to be analyzed, as shown below.

In some embodiments, each cluster 62a-c consists only of records sharing a subset of features. For example, object aggregator 54 may put two records A and B in the same cluster when:

Fᵢ^{A}=Fᵢ^{B}, for all iεS, [1]

wherein Fᵢ^{A} denotes the i-th element of the feature vector of corpus record A, Fᵢ^{B} denotes the i-th element of the feature vector of corpus record B, and wherein S denotes a subset of indices into the feature vector (e.g, S={1, 3, 6} stands for the first, third and sixth elements of each feature vector). In some embodiments, records A and B share a set of features, and are therefore assigned to the same cluster, when the corresponding feature vector elements differ by at most a small amount δᵢ:

|Fᵢ^{A}−Fᵢ^{B}|≦δᵢ, for all iεS, [2]

In some embodiments, records are aggregated into clusters using inter-vector distances determined in feature space. To perform such clustering, object aggregator 54 may use any method known in the art, such as k-means or k-medoids, among others. Inter-vector distances in feature space may be computed as Euclidean distances, Manhattan distances, edit distances, or combinations thereof.

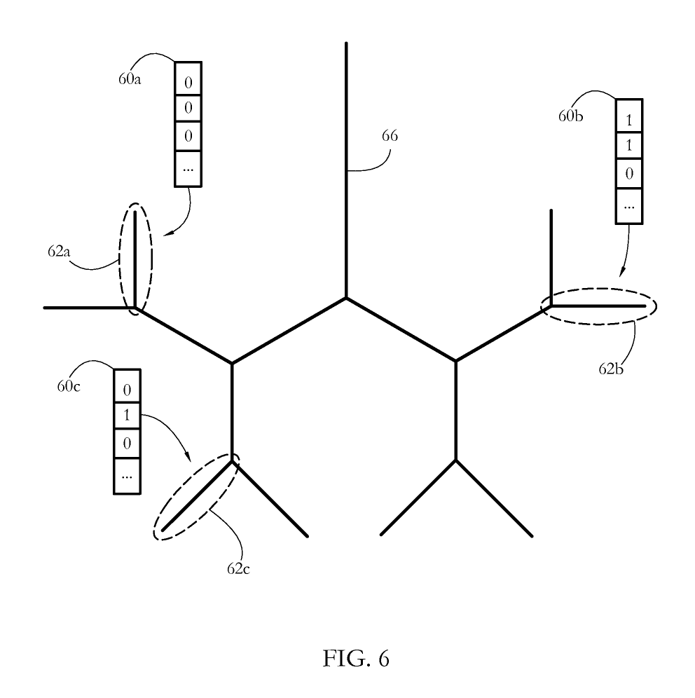

FIG. 6 illustrates an exemplary record clustering method, wherein each cluster is represented by a branch of a feature tree 66. In some embodiments, feature tree 66 is constructed such that each branch of tree 66 corresponds to a specific sequence of values {Fᵢ}, iεS, of the feature vector. For instance, when S denotes a subset of features having binary values (0/1, yes/no), feature tree 66 is a binary tree such as the one illustrated in FIG. 6, wherein each node corresponds to a feature, and wherein each branch coming out of the respective node indicates a feature value. For instance, in FIG. 6, the trunk may denote feature i1. A left branch of the trunk denotes all feature vectors having Fᵢ₁=0, and a right branch denotes all feature vectors having Fᵢ₁=1. Each such branch has two sub-branches corresponding to all feature vectors having Fᵢ₂=0, and Fᵢ₂=1, respectively, and so on. In the example of FIG. 6, branch 62a represents a cluster of corpus records, all members of cluster 62a having {Fᵢ₁=0, Fᵢ₂=0, Fᵢ₃=0}, branch 62b represents a cluster of corpus records, wherein all members have {Fᵢ₁=1, Fᵢ₂=1, Fᵢ₃=0}, and branch 62c represents a cluster of corpus records, wherein all members have {Fᵢ₁=0, F₇₂=1, Fᵢ₃=0}. The clustering of FIG. 6 can be seen as an application of Eqn. [1] to a subset S of binary-valued features.

In some embodiments, a feature-selection algorithm may be used to select an optimal subset of binary features S for clustering corpus 40. For instance, subset S may comprise features, which are particularly successful in discriminating between clean and malware records. One feature selection criterion known in the art, which selects binary features according to their discriminating power, is information gain.

An alternative criterion selects features, which divide corpus 40 into clusters of approximately the same size. Some embodiments select features which appear in roughly half of the malware records of corpus 40, and also in half of the clean records of corpus 40. When such features are used for clustering, each daughter branch of a mother branch of feature tree 66 has approximately half of the elements of the mother branch. An exemplary feature selection which achieves such clustering comprises selecting a feature i according to a score:

$${Σ}_{i} = 1 - \frac{\vert {freq}_{i}^{malicious} - 0.5 \vert + \vert {freq}_{i}^{clean} - 0.5 \vert}{2} , \qquad [ 3 ]$$

wherein freqᵢ^{malicious} denotes a frequency of records having Fᵢ=1 among records of corpus 40 labeled as malicious (e.g., number of records labeled as malicious having Fᵢ=1, divided by the total number of records labeled as malicious), and wherein freqᵢ^{clean} denotes a frequency of records having Fᵢ=1 among records of corpus 40 labeled as clean. Eqn. [3] produces high scores in the case of features, which are present in approximately half of the malware records, and also present in approximately half of the clean records. Features i may be ranked in the order of descending score Σᵢ, and a subset of features having the highest scores may be selected for clustering.

The number (count) of features selected for clustering corpus 40 may be chosen according to computation speed criteria. A large number of features typically produces a substantially higher number of clusters 62a-c, having substantially fewer members per cluster, than a small number of features. Considering a large number of features may significantly slow down clustering of corpus 40, but in return it may the expedite de-noising of the respective, smaller, clusters.

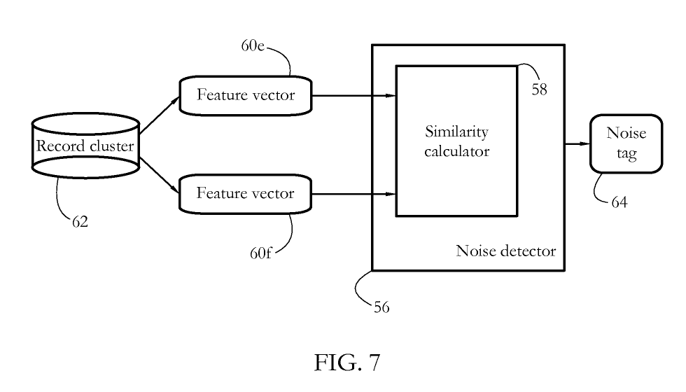

In some embodiments, in response to dividing noisy corpus 40 into clusters of similar items 62a-c, object aggregator 54 (FIG. 3) sends each cluster 62a-c to a noise detector 56a-c for de-noising. Each cluster 62a-c is processed independently of other clusters, either sequentially, or in parallel. Noise detectors 56a-c may be distinct programs, or identical instances of the same program, executing concurrently on the same processor, or executing in parallel on a multi-processor computing system. Each noise detector 56a-c is configured to input object cluster 62a-c and to produce noise tags 64a-c indicating members of the respective cluster identified as noise. In some embodiments, such as the one illustrated in FIG. 7, a noise detector 56 comprises a similarity calculator 58 configured to receive a pair of feature vectors 60e-f selected from cluster 62, and to determine a similarity measure indicative of a degree of similarity between vectors 60e-f. Noise detector 62 may further determine whether either one of vectors 60e-f is noise according to the respective similarity measure.

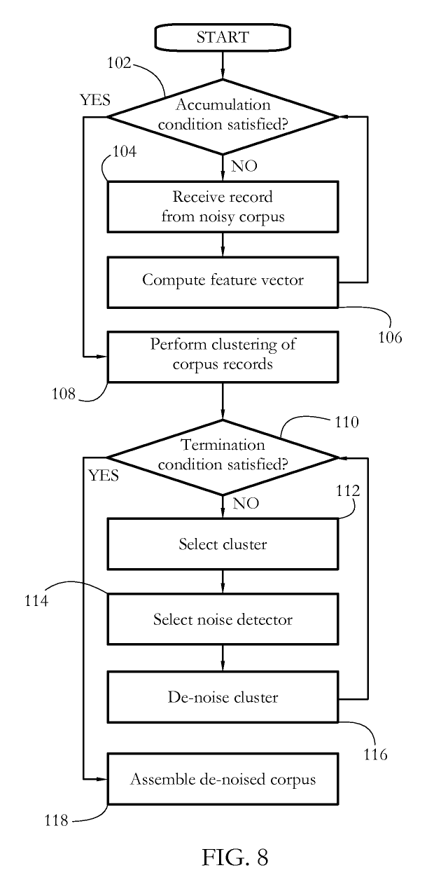

FIG. 8 shows an exemplary sequence of steps performed by de-noising engine 12 (FIG. 3) according to some embodiments of the present invention. Engine 12 may execute a sequence of steps 102-106 in a loop, until an object accumulation condition is satisfied. Steps 102-106 effectively select a subset of corpus records 48 for analysis from corpus 40. The subset may comprise the entire noisy corpus 40. Alternatively, the subset of corpus 40 may be selected according to a time criterion, or according to a computation capacity criterion, among others. For example, engine 12 may execute according to a schedule, e.g., to de-noise a subset of items received and incorporated in noisy corpus 40 during the latest day or hour. In another embodiment, engine 12 may select a predetermined count of items, for instance 1 million corpus records 48 for processing. Step 102 determines whether the accumulation condition for selecting records 48 is satisfied (e.g., whether the count of selected records has reached a predetermined limit), and if yes, engine 12 proceeds to a step 108 described below. If no, in a step 104, engine 12 selects corpus record 48 from noisy corpus 40. Next, in a step 106, feature extractor 52 computes feature vector 60 of corpus record 48, as described above. Following step 106, engine 12 returns to step 102.

In step 108, object aggregator 54 performs a clustering of the subset of corpus 40 selected in steps 102-106, to produce a plurality of record clusters. Such clustering may proceed according to the exemplary methods described above, in relation to FIGS. 5-6. Next, de-noising engine 12 may execute a sequence of steps 110-116 in a loop, individually for each cluster determined in step 108.

In a step 110, engine 12 determines whether a termination condition is satisfied. Exemplary termination conditions include having de-noised the last available cluster of corpus objects, and the expiration of a deadline, among others. When the termination condition is satisfied, engine 12 proceeds to a step 118 outlined below. When the condition is not satisfied, in a step 112, de-noising engine 12 may select a cluster of objects from the available clusters determined in step 108. Next, in a step 114, engine 12 selects a noise detector from available noise detectors 56a-c (FIG. 3), and assigns the cluster selected in step 112 to the respective noise detector for processing. Such assignment may consider particularities of the selected cluster (e.g., a count of members and/or a selection of cluster-specific feature values, among others), and/or particularities of noise detectors 56a-c (e.g., hardware capabilities and a degree of loading, among others). In a step 116, the selected noise detector processes the selected cluster to produce noise tags 64a-c indicating members of the selected cluster identified as noise. An exemplary operation of noise detectors 56a-c is shown below. Following step 116, engine 12 returns to step 110.

In a step 118, de-noising engine 12 assembles de-noised corpus 42 according to noise tags 64a-c produced by noise detectors 56a-c. In some embodiments, de-noised corpus 42 comprises a version of noisy corpus 40, wherein items of corpus 40 identified as noise are either missing, or have been modified by engine 12. To assemble de-noised corpus 42, de-noising engine 12 may copy into corpus 42 all analyzed records of noisy corpus 40, which have been identified as not being noise. When a record of corpus 40 has been analyzed in steps 102-116 and identified as noise, engine 12 may not copy the respective record into de-noised corpus 42. Alternatively, some embodiments of engine 12 may copy a record identified as noise, but change its label. For instance, engine 12 may re-label all noise as clean records upon copying the respective records to de-noised corpus 42. In some embodiments, step 118 may further comprise annotating each record transcribed into de-noised corpus 42 with details of the de-noising process. Such details may comprise a timestamp indicative of a time when the respective record has been analyzed, and an indicator of a de-noising method being applied in the analysis, among others.

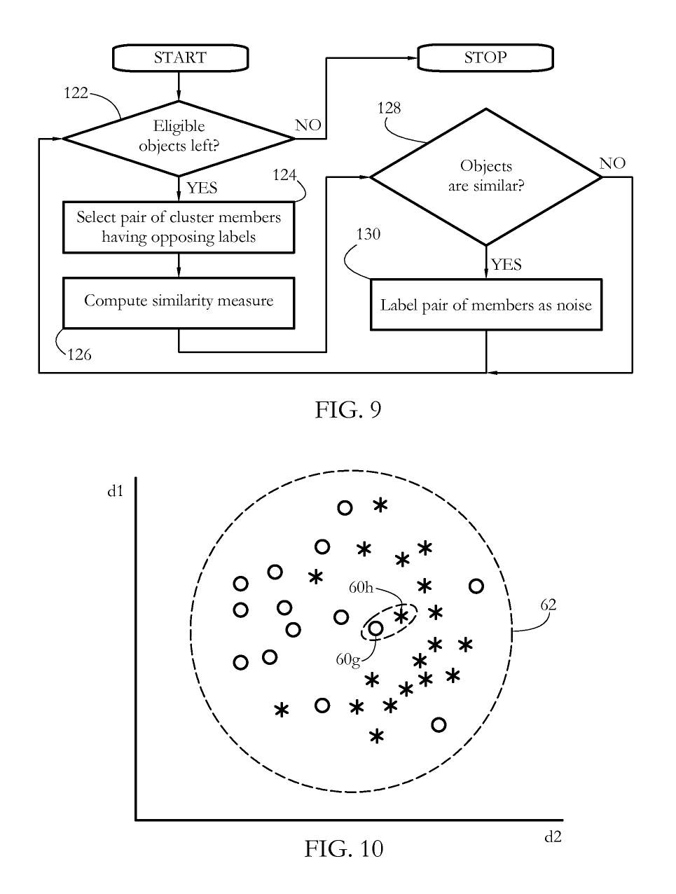

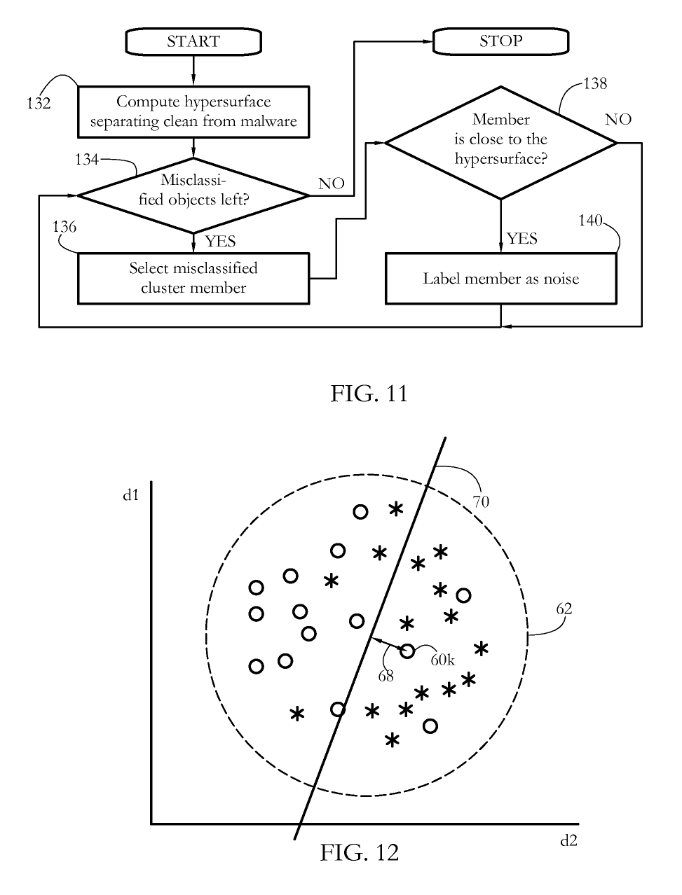

FIG. 9 shows an exemplary sequence of steps executed by noise detector 56 (FIG. 7) to identify noise within cluster 62 according to some embodiments of the present invention. FIG. 9 illustrates an exemplary procedure for executing step 116 in FIG. 8. A sequence of steps 122-130 is carried out in a loop, for each pair of eligible members of cluster 62. In a step 122, noise detector 56 determines whether there are any eligible cluster members left to analyze, and if no, detector 56 quits. If yes, a step 124 selects an eligible pair of members from cluster 62. In some embodiments, an eligible pair comprises two records of cluster 62 having opposing labels (e.g., one record of the pair labeled as malware, and the other as clean), the respective pair not having already been selected for analysis in a previous run of step 124. An exemplary eligible pair of records 60g-h is illustrated in FIG. 10, wherein circles represent malware records, and stars represent clean records of cluster 62.

In a step 126, noise detector 56 determines a similarity measure indicative of a degree of similarity between the pair of records selected in step 122, by employing a software component such as similarity calculator 58 in FIG. 7. In some embodiments, determining the similarity measure includes computing a feature space distance between the feature vectors corresponding to the pair of records 60g-h. Many such distances are known in the art. For instance, for a subset of features B consisting only of binary-valued features, similarity calculator 58 may compute a Manhattan distance:

$${d}_{1} = {\sum }_{i = 1}^{\# B} \vert {F}_{i}^{1} - {F}_{i}^{2} \vert , \qquad [ 4 ]$$

wherein #B denotes the cardinality (number of elements) of the set B, Fᵢ¹ denotes the i-th element of the feature vector of the first corpus record of the pair, and Fᵢ² denotes the i-th element of the feature vector of the second corpus record of the pair. Alternatively, similarity calculator may determine a similarity measure according to a percent-difference distance:

$$\frac{{\sum }_{i = 1}^{N} \vert {F}_{i}^{1} - {F}_{i}^{2} \vert}{\# \{ i = 1 , 2 , … , N so that {F}_{i}^{1} = 1 OR {F}_{i}^{2} = 1 \}} , \qquad [ 5 ]$$

wherein # denotes a cardinality of the set in brackets. In Eqn. [5], the Manhattan distance is scaled by a count of features having the value 1 (true) in at least one of the respective pair of records.

In some embodiments, a weighted version of the d₁ and/or d₂ distance may be computed:

$${d}_{3} = {\sum }_{i = 1}^{\# B} {w}_{i} \cdot \vert {F}_{i}^{1} - {F}_{i}^{2} \vert , \qquad [ 6 ]$$

wherein wᵢ denote a set of feature-specific weights. Weight wᵢ may be determined according to a performance of the respective feature i in discriminating between malware and clean corpus records, e.g., features having more discriminating power may be given higher weight than features appearing frequently in both malware and clean records. Weight values may be determined by a human operator, or may be determined automatically, for instance according to a statistical analysis of noisy corpus 40. In some embodiments, weight wᵢ is determined according to a feature-specific score:

$${s}_{1}^{i} = \frac{{( {μ}_{i}^{malicious} - {\overline{μ}}_{i} )}^{2} + {( {μ}_{i}^{clean} - {\overline{μ}}_{i} )}^{2}}{{( {σ}_{i}^{malicious} )}^{2} + {( {σ}_{i}^{clean} )}^{2}} , \qquad [ 7 ]$$

wherein μᵢ^{malicious} and σᵢ^{malicious} denote a mean and a standard deviation of the values of feature i, respectively, determined over all records of noisy corpus labeled as malicious, μᵢ^{clean} and σᵢ^{clean} denote a mean and a standard deviation of the values of feature i, determined over all records of corpus 40 labeled as clean, and wherein μ̅ᵢ denotes a mean value of feature i, determined over all records of corpus 40 (malicious as well as clean).

Alternatively, weight wᵢ may be determined according to a feature-specific score:

s₂ⁱ=|#{clean records wherein Fᵢ=1}−#{malware records wherein Fᵢ=1}|, [8]

which counts the clean and malicious records in corpus 40 wherein feature i has the value 1 (true). In some embodiments, weight wᵢ is calculated by rescaling scores sⁱ₁ and/or sⁱ₁ to the interval [0,1].

In a step 128, noise detector 56 determines whether the records selected in step 124 are similar. In some embodiments, step 128 comprises comparing the similarity measure determined in step 126 to a pre-determined threshold. Some embodiments determine that two records are similar when the similarity measure (e.g., distance d₁) computed for the pair is lower than said threshold. The threshold may be corpus-independent, for instance two records are deemed similar when they differ by at most a predetermined number of feature vector elements, i.e., Fᵢ^{A}≠Fᵢ^{B}, for a number of indices i, the number smaller than a predetermined limit, e.g., 5. The threshold may be also corpus-dependent, or cluster-dependent. For instance, after determining distances separating all eligible pairs of records (step 116), noise detector 56 may set the threshold to a fraction of the maximum distance found. In such a case, noise detector 56 may deem two records to be similar when their similarity measure is, for instance, within 10% of the maximum similarity measure determined for the current cluster. When step 128 found that the records are not similar, noise detector returns to step 122.

When the records selected in step 124 are found to be similar, in a step 130 noise detector 56 may label both the respective records as noise, and return to step 122. In some embodiments, step 130 may further comprise attaching noise tag 64 to each record of the pair.

FIG. 10 shows an exemplary sequence of steps executed by an alternative embodiment of noise detector 56. In a step 132, noise detector 56 determines a hypersurface in feature space, the hypersurface separating malware from clean records of cluster 62 currently being de-noised. Exemplary hypersurfaces include plane, spherical, elliptic, and hyperbolic surfaces, among others. In some embodiments, step 132 may determine a hyperplane achieving optimal separation of malware from clean records, employing, for instance, a support vector machine (SVM) algorithm or another classifier known in the art of machine learning. Such an exemplary hyperplane 70 is illustrated in FIG. 12. Hyperplane 70 divides feature space in two regions, corresponding to malware (upper-left region, circles in FIG. 12) and clean records (lower-right region, stars in FIG. 12), respectively. Following computation of hyperplane 70, some records are misclassified, i.e., are located in the wrong region; for instance, record 60k in FIG. 12 is located on the “clean” side of hyperplane 70, although record 60k is labeled as malware. A sequence of steps 134-140 is executed in a loop, for each such misclassified record 60k,

In a step 134, noise detector 56 determines whether there are any outstanding misclassified records following calculation of hyperplane 70, and if no, detector 56 quits. If yes, a step 136 selects a misclassified record of cluster 62, i.e., either a clean record located on the malware side of hyperplane 70, or a malware record located on the clean side of hyperplane 70. In a step 138, noise detector 56 determines if the selected record is close to the hypersurface calculated in step 132, and if no, noise detector 56 returns to step 134. In the embodiment illustrated in FIG. 12, step 138 comprises computing a feature space distance separating the selected record from hyperplane 70, and comparing the distance to a threshold. An exemplary record-to-hyperplane distance 68 is illustrated in FIG. 12 for misclassified record 60k. In some embodiments, the threshold may be cluster-independent, while in other embodiments it may be calculated as a fraction (e.g., 10%) of the maximum record-to-hyperplane distance of all misclassified records in cluster 62.

When the distance calculated in step 138 is below the respective threshold, noise detector 56 may determine that the selected record is close to hyperplane 70. In such a case, in a step 140, noise detector 56 labels the selected record as noise, and returns to step 134. In some embodiments, prior to labeling the selected record as noise, detector 56 may buffer all selected records eligible to be labeled as noise (i.e., records that have been identified as being close to the hypersurface calculated in step 132), may order these selected records according to their distance to the hypersurface, and may select for labeling as noise a predetermined count of records. For instance, noise detector 56 may label as noise 1000 misclassified records, located closest to the classification hypersurface.

The exemplary systems and methods described above enable the reduction of noise found in databases (corpuses) used for training automatic classifiers for anti-malware applications. Noise, consisting of mislabeled corpus records, i.e., clean or benign records wrongly classified as malware, or malware wrongly classified as clean, has a detrimental effect on training classifiers such as neural networks.

In conventional anti-malware systems, noise is often hand-picked by human operators, and discarded from the corpus prior to using the corpus for training. Instead of using human-supervised de-noising, some embodiments of the present invention are configured to automatically identify noise within a corpus, and subsequently discard or re-label records identified as noise. Training data is typically gathered automatically, in quasi-real time, to keep track of continuously evolving types and instances of malware, such as computer viruses, rootkits, and spyware, among others. Such corpuses of training data may often comprise millions of records, amounting to several gigabytes of data. By allowing the automatic detection of noise, some embodiments of the present invention allow for processing such large data sets.

Some embodiments of the present invention identify noise according to a set of inter-record distances computed in a hyperspace of features. For a number of records N, the number of inter-record distances typically scales as N², which may quickly become impractical for large record sets. Instead of de-noising an entire training corpus in one operation, some embodiments of the present invention perform a clustering of the training corpus in smaller, disjoint collections of similar items, prior to actual de-noising. Each cluster of records may then be de-noised independently of other clusters, thus significantly reducing computation time. Such division of the corpus into subsets of records may also be more conducive to performing the de-noising procedures on a parallel computer.

To detect noise, some embodiments of the present invention target pairs of records, which have opposing labels (one record is labeled as clean, while the other is labeled as malware). When two such records are found to be similar, in the sense that they share a majority of features and/or are sufficiently close in feature space, in some embodiments the respective records are labeled as noise, and are either discarded from the training corpus, or re-labeled.

Another embodiment of the present invention computes a hypersurface, such as a hyperplane, separating clean-labeled from malware-labeled records in feature space, and targets records, which are misclassified according to the position of the hypersurface. When such a misclassified record is located sufficiently close to the hypersurface, it may be labeled as noise and either discarded from the training corpus, or relabeled.

To illustrate the operation of an exemplary de-noising engine, a calculation was conducted using a parallel computer with 16 cores (threads). A test corpus consisting of 24,966,575 files was assembled from multiple file collections downloaded from various Internet sources, all files of the corpus pre-labeled as clean or malware. Of the total file count of the corpus, 21,905,419 files were pre-labeled clean and 3,061,156 were pre-labeled malware. Each record of the test corpus was characterized using a set of 14,985 distinct features.

A mini-corpus of 97,846 records was selected from the test corpus, and Manhattan distances between all pairs of records of the mini-corpus were evaluated, an operation that took approximately 1 hour and 13 minutes on said parallel computer. Based on this actual computation, an order-of magnitude estimation revealed that computing all inter-record distances required for de-noising the whole test corpus would require about 9 years of continuous computation. This vast computational effort may be massively reduced by dividing the corpus into clusters of similar items, according to some embodiments of the present invention.

The test corpus was separated into clusters using an algorithm similar to the one depicted in FIG. 6. Several feature selection criteria were employed to perform the clustering, including selecting features having the highest s₁ score (Eqn. [7]), selecting features having the highest s₂ score (Eqn. [8]), and selecting features having the highest Σ score (Eqn. [3]). Results of clustering are shown in Table 1.

TABLE 1

| | Number of | Max. cluster | Estimated time to |
|---|---|---|---|
| Feature selection | clusters | size | de-noise corpus |
| highest s₁ scores [7] | 6,380 | 4,253,007 | 11 days |
| highest s₂ scores [8] | 958 | 6,314,834 | 177 days |
| highest Σ scores [3] | 42,541 | 61,705 | 3 hours 30 minutes |
| Information gain | 12 | 9,784,482 | 1.5 years |

As seen in Table 1, a de-noising engine configured for parallel processing and using, for instance, the Σ score for feature selection, may be capable of producing de-noised corpus 42 within hours.

One of the clusters produced as a result of clustering the test corpus was de-noised using various expressions for inter-record distances, and using an algorithm similar to the one illustrated in FIGS. 9-10. Two records having opposing labels were considered noise candidates when the inter-record distance was less than 5% of the largest distance between a malware-labeled record and a clean-labeled record of the cluster. Such noise candidates were evaluated manually, to identify actual noises and records wrongly identified as noise. An exemplary calculation, using the Manhattan expression for inter-record distances, identified a set of noise candidates, which included 47.5% of the actual noise of the respective cluster; out of the set of candidates, 9.5% were actual noise.

It will be clear to one skilled in the art that the above embodiments may be altered in many ways without departing from the scope of the invention. Accordingly, the scope of the invention should be determined by the following claims and their legal equivalents.

What is claimed is:

1. A computer system comprising at least one processor configured to form a set of noise detectors, each noise detector of the set of noise detectors configured to de-noise a corpus of records, wherein the corpus is pre-classified into a subset of clean records and a subset of malware records prior to de-noising, and wherein de-noising the corpus comprises:
selecting a first record and a second record from the corpus, the first record being labeled as clean and the second record being labeled as malware;
in response to selecting the first and second records, determining whether the first and second records are similar according to a set of features; and
in response, when the first and second records are similar, determine that the first and second records are noise.

2. The computer system of claim 1, further configured, in response to determining that the first and second records are noise, to remove the first and second records from the corpus.

3. The computer system of claim 1, wherein the at least one processor is further configured, in response to determining that the first and second records are noise, to re-label the second record as clean.

4. The computer system of claim 1, wherein determining whether the first and second records are similar comprises:
determining a distance in a feature hyperspace, the distance separating a first feature vector from a second feature vector, the first feature vector determined for the first record and the second feature vector determined for the second record;
in response to determining the distance, comparing the distance to a pre-determined threshold; and
determining whether the first and second records are similar according to a result of the comparison.

5. The computer system of claim 4, wherein the distance is determined according to w|F¹−F²|, wherein F¹ is an element of the first feature vector, F¹ indicating whether the first record has a selected feature, wherein F² is an element of the second feature vector, F² indicating whether the second record has the selected feature, and wherein w denotes a weight of the selected feature, the weight determined according to a count of clean-labeled records of the corpus having the selected feature, and further according to a count of malware-labeled records of the corpus having the selected feature.

6. The computer system of claim 4, further configured to determine a first set of values of a selected feature and a second set of values of the selected feature, wherein each value of the first set of values is determined for a malware record of the corpus and indicates whether the malware record has the selected feature, wherein each value of the second set of values is determined for a clean record of the corpus and indicates whether the clean record has the selected feature, and wherein the distance is determined according to
$$\frac{{( {μ}^{malicious} - \overline{μ} )}^{2} + {( {μ}^{clean} - \overline{μ} )}^{2}}{{( {σ}^{malicious} )}^{2} + {( {σ}^{clean} )}^{2}}$$
wherein μ^{malicious} and σ^{malicious} denote a mean and a standard deviation of the first set of values, respectively, wherein, μ^{clean} and σ^{clean} denote a mean and a standard deviation of second set of values, respectively, and wherein μ̅ denotes a mean value of the selected feature, the mean value of the selected feature, the mean value determined over all records of the corpus.

7. The computer system of claim 1, further configured to:
determine a hyperplane dividing the corpus into a clean region of a feature hyperspace and a malware region of the feature hyperspace;
in response to determining the hyperplane, select a third record of the corpus, the third record being labeled as malware, the third record being located in the clean region of feature hyperspace;
determine whether the third record is close to the hyperplane according to a comparison between a distance separating the third record from the hyperplane and a predetermined threshold; and
in response, when the third record is close to the hyperplane, determine that the third record is noise.

8. The computer system of claim 1, further configured to:
determine a hyperplane dividing the corpus into a clean region of a feature hyperspace and a malware region of the feature hyperspace;
in response to determining the hyperplane, select a third record of the corpus, the third record being labeled as clean, the third record being located in the malware region of feature hyperspace;
determine whether the third record is close to the hyperplane according to a comparison between a distance separating the third record from the hyperplane and a predetermined threshold; and
in response, when the third record is close to the hyperplane, determine that the third record is noise.

9. The computer system of claim 1, further configured to form a filter training engine connected to the set of noise detectors and configured to train an automated classifier to discriminate between malware and clean records according to an output of the set of noise detectors.

10. The computer system of claim 1, wherein de-noising the corpus further comprises:
before selecting the first and second records, dividing the corpus of records into a plurality of clusters, wherein all members of a cluster of the plurality of clusters share a selected set of features; and
in response to dividing the corpus into the plurality of clusters, selecting the first and second records from a first cluster of the plurality of clusters.

11. The computer system of claim 10, wherein dividing the corpus into the plurality of clusters comprises selecting a feature i of the selected set of features according to a proximity between a first count and a first reference, and further according to a proximity between a second count and a second reference, wherein the first count is a count of malware-labeled records of the corpus having feature i, wherein the second count is a count of clean-labeled records of the corpus having feature i, wherein the first reference is equal to half of the cardinality of the subset of malware records, and wherein the second reference is equal to half of the cardinality of the subset of clean records.

12. The computer system of claim 11, wherein dividing the corpus into the plurality of clusters comprises selecting a feature i of the selected set of record features according to:

|freqᵢ^{malicious}−0.5|+|freqᵢ^{clean}−0.5|,
wherein freqᵢ^{malicious} denotes a frequency of appearance of feature i within the subset of malware records of the corpus, and wherein freqᵢ^{clean} denotes a frequency of appearance of feature i within the subset of clean records of the corpus.

13. The computer system of claim 10, wherein a first noise detector of the plurality of noise detectors executes on a first processor of the computer system, wherein a second noise detector of the plurality of noise detectors executes on a second processor of the computer system, the second processor distinct from the first processor, wherein the first noise detector is configured to de-noise the first cluster, and wherein the second noise detector is configured to de-noise a second cluster of the plurality of clusters, the second cluster distinct from the first cluster.

14. The computer system of claim 10, wherein the distance is determined according to
$$\frac{{\sum }_{i = 1}^{N} \vert {F}_{i}^{1} - {F}_{i}^{2} \vert}{\# \{ i = 1 , 2 , … , N so that {F}_{i}^{1} = 1 OR {F}_{i}^{2} = 1 \}} ,$$
wherein Fᵢ¹ is an element of the first feature vector, Fᵢ¹ indicating whether the first record has feature i, wherein Fᵢ² is an element of the second feature vector, Fᵢ² indicating whether the second record has feature i, wherein N denotes the count of features, and wherein # denotes a cardinality of the set in brackets.

15. A method comprising:
employing at least one processor of a computer system to select a first record and a second record from a corpus, wherein the corpus is pre-classified into a subset of clean records and a subset of malware records prior to selecting the first and second records, and wherein the first record is labeled as clean and the second record is labeled as malware;
in response to selecting the first and second records, employing the at least one processor to determine whether the first and second records are similar according to a set of features; and
in response, when the first and second records are similar, employing the at least one processor to determine that the first and second records are noise.

16. The method of claim 15, further comprising, in response to determining that the first and second records are noise, removing the first and second records from the corpus.

17. The method of claim 15, further comprising, in response to determining that the first and second records are noise, re-labeling the second record as clean.

18. The method of claim 15, wherein determining whether the first and second records are similar comprises:
employing the at least one processor to determine a distance in a feature hyperspace, the distance separating a first feature vector from a second feature vector, the first feature vector determined for the first record and the second feature vector determined for the second record;
in response to determining the distance, employing the at least one processor to compare the distance to a pre-determined threshold; and
employing the at least one processor to determine whether the first and second records are similar according to a result of the comparison.

19. The method of claim 18, comprising determining the distance according to w|F¹−F²|, wherein F¹ is an element of the first feature vector, F¹ indicating whether the first record has a selected feature, wherein F² is an element of the second feature vector, F² indicating whether the second record has the selected feature, and wherein w denotes a weight of the selected feature, the weight determined according to a count of clean records of the corpus having the selected feature, and further according to a count of malware records of the corpus having the selected feature.

20. The method of claim 18, further comprising determining a first set of values of a selected feature and a second set of values of the selected feature, wherein each value of the first set of values is determined for a malware record of the corpus, indicating whether the malware record has the selected feature, wherein each value of the second set of values is determined for a clean record of the corpus, indicating whether the clean record has the selected feature, and wherein the distance is determined according to
$$\frac{{( {μ}^{malicious} - \overline{μ} )}^{2} + {( {μ}^{clean} - \overline{μ} )}^{2}}{{( {σ}^{malicious} )}^{2} + {( {σ}^{clean} )}^{2}}$$
wherein μ^{malicious} and σ^{malicious} denote a mean and a standard deviation of the first set of values, respectively, wherein, μ^{clean} and σ^{clean} denote a mean and a standard deviation of second set of values, respectively, and wherein μ̅ denotes a mean value of the selected feature, the mean value of the selected feature, the mean value determined over all records of the corpus.

21. The method of claim 15, further comprising:
employing the at least one processor to determine a hyperplane dividing the corpus into a clean region of a feature hyperspace and a malware region of the feature hyperspace;
in response to determining the hyperplane, employing the at least one processor to select a third record of the corpus, the third record being labeled as malware, the third record being located in the clean region of feature hyperspace;
employing the at least one processor to determine whether the third record is close to the hyperplane according to a comparison between a distance separating the third record from the hyperplane and a predetermined threshold; and
in response, when the third record is close to the hyperplane, employing the at least one processor to determine that the third record is noise.

22. The method of claim 15, further comprising:
employing the at least one processor to determine a hyperplane dividing the corpus into a clean region of a feature hyperspace and a malware region of the feature hyperspace;
in response to determining the hyperplane, employing the at least one processor to select a third record of the corpus, the third record being labeled as clean, the third record being located in the malware region of feature hyperspace;
employing the at least one processor to determine whether the third record is close to the hyperplane according to a comparison between a distance separating the third record from the hyperplane and a predetermined threshold; and
in response, when the third record is close to the hyperplane, employing the at least one processor to determine that the third record is noise.

23. The method of claim 15, further comprising training an automated classifier to discriminate between malware and clean records according to a result of determining that the first and second records are noise.

24. The method of claim 15, further comprising:
before selecting the first and second records, employing the at least one processor to divide the corpus of records into a plurality of clusters, wherein all members of a cluster of the plurality of clusters share a selected set of features; and
in response to dividing the corpus into the plurality of clusters, employing the at least one processor to select the first and second records from a first cluster of the plurality of clusters.

25. The method of claim 24, wherein dividing the corpus into the set of clusters comprises selecting feature i of the selected set of features according to a proximity between a first count and a first reference, and further according to a proximity between a second count and a second reference, wherein the first count is a count of malware-labeled records of the corpus having feature i, wherein the second count is a count of clean-labeled records of the corpus having feature i, wherein the first reference is equal to half of the cardinality of the subset of malware records, and wherein the second reference is equal to half of the cardinality of the subset of clean records.

26. The method of claim 25, wherein dividing the corpus into the set of clusters comprises selecting a feature i of the selected set of features according to:

|freqᵢ^{malicious}−0.5|+|freqᵢ^{clean}−0.5|,
wherein freqᵢ^{malicious} denotes a frequency of appearance of feature i within the subset of malware records of the corpus, and wherein freqᵢ^{clean} denotes a frequency of appearance of feature i within the subset of clean records of the corpus.

27. The method of claim 24, further comprising, in response to dividing the corpus into the plurality of clusters:
employing a first processor of the computer system to select the first and second records from the first cluster, to determine whether the first and second records are noise; and
employing a second processor of the computer system to select a third and a fourth records from a second cluster of the plurality of clusters, to determine whether the third and fourth records are noise,
wherein the second cluster is distinct from the first cluster, and wherein the second processor is distinct from the first processor.

28. The method of claim 24, wherein the distance is determined according to
$$\frac{{\sum }_{i = 1}^{N} \vert {F}_{i}^{1} - {F}_{i}^{2} \vert}{\# \{ i = 1 , 2 , … , N so that {F}_{i}^{1} = 1 OR {F}_{i}^{2} = 1 \}} ,$$
wherein Fᵢ¹ is an element of the first feature vector, Fᵢ¹ indicating whether the first record has feature i, wherein Fᵢ² is an element of the second feature vector, Fᵢ² indicating whether the second record has feature i, wherein N denotes the count of features, and wherein # denotes a cardinality of the respective set.

29. A computer readable medium storing a set of instructions, which, when executed by a computer system, cause the computer system to form a record aggregator and a noise detector connected to the record aggregator, wherein the record aggregator is configured to:
assign records of a corpus to a plurality of clusters, wherein each record of the corpus is pre-labeled as either clean or malware prior to assigning records to the plurality of clusters, and wherein all members of a cluster of the plurality of clusters share a selected set of record features; and
in response to assigning the records to the plurality of clusters, send a target cluster of the plurality of clusters to the noise detector for de-noising;
and wherein the noise detector is configured, in response to receiving the target cluster, to:
select a first record and a second record from the target cluster, the first record being labeled as clean and the second record being labeled as malware;
in response to selecting the first and second records, determine whether the first and second records are similar according to a set of features; and
in response, when the first and second records are similar, determine that the first and second records are noise.
